(19) United States
(12) Patent Application Publication
(10) Pub. No.: US 2010/0206491 A1
(43) Pub. Date: Aug. 19, 2010

(54) VENETIAN BLIND WITH A THIN PROFILE LATTICED STRIP

(75) Inventor: Tsung-Hsiung TSAI, Jhushan Township (TW)

Correspondence Address: EGBERT LAW OFFICES, 412 MAIN STREET, 7TH FLOOR, HOUSTON, TX, 77002, US

(73) Assignee: TAIHAO KNITTING BELT Co., Ltd., Chanping Dongguan City (CN)

(21) Appl. No.: 12/371,337

(22) Filed: Feb. 13, 2009

(51) Int. Cl. E06B 9/30

(52) U.S. Cl. 160/168.1 R

(57) ABSTRACT

The present invention provides a venetian blind with a thin profile latticed strip. The blind includes a bracket, several thin blades arranged under the bracket with threading holes, a blade regulator, and at least two narrow shaped and thin profile latticed strips extending from the bottom of the bracket. The strips each include a front and a rear strip body as well as a blade span connected transversely between front and rear strip bodies. The front and rear strip bodies are positioned correspondingly to the threading hole of the thin blade. When the thin blade is adjusted to a vertical light-shading angle, the threading hole of the thin blade can be fully blocked by the front and rear strip bodies. Due to the thin-profile structure of the latticed strip, when the thin blades are superimposed, a compact spacing among the thin blades can be kept.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a venetian blind, and more particularly to an innovative venetian blind with narrow shaped and thin profile latticed strips.

2. Description of Related Art Including Information Disclosed Under 37 CFR 1.97 and 37 CFR 1.98

There is a huge market for venetian blinds due to their advantages of regulating light entering through a window. However, some problems have to be resolved due to different structural features of the venetian blinds.

Referring to FIG. 1, the blades 11 of the existing venetian blind 10 are generally of a thin profile structure (e.g. aluminum or plastic sheets), so that the blades 11 are connected and positioned at intervals by a grid line 12 for simultaneous oscillation. On the other hand, long through-holes 13 are opened correspondingly on the blades 11, permitting the penetration of the lifting rope 14 in sequence through the blades 11.

Yet, there are the following shortcomings are observed during actual applications. Given the light transmission of the long through-holes 13 on the blades 11, no problem can be found when the blades 11 are arranged in a transverse state. The optimum light-shading effect may be realized when the blades 11 are adjusted to a vertical state (i.e. the state shown in FIG. 1). Since two long through-holes 13, at a minimum, are opened on the blades 11, external light will penetrate the blades 11 from long through-holes 13 and cause serious light leakage even if the blades 11 are adjusted vertically. Notwithstanding, the grid line 12 is positioned corresponding to the long through-hole 13. It is thus impossible to block off efficiently the light from long through-hole 13, so that the typical thin profile venetian blind cannot realize optimization of a light-shading effect in practice.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the unique present invention, each thin blade is structurally combined with a narrow shaped and thin profile latticed strip. When the thin blade of the venetian blind is adjusted to a vertical light-shading angle, the threading hole of the thin blade can be fully blocked by front and rear strip bodies so as to improve substantially the light-shading effect. Furthermore, due to the thin profile structure of the latticed strip, when the thin blades of the venetian blind are superimposed, a compact spacing among the thin blades can be kept, thereby improving greatly the performance and applicability of the thin profile venetian blind.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a partial perspective view of typical venetian blind.

FIG. 2 shows a structural perspective view of venetian blind of the present invention.

FIG. 3 shows an enlarged perspective view of position B of FIG. 2.

FIG. 4 shows a partial perspective view of a latticed strip of the present invention.

FIG. 5 shows a partial side elevation view of the present invention.

FIG. 6 shows a perspective view of the present invention, showing the blade under a vertical light-shading state.

FIG. 7 shows a front elevation view ofthe present invention, showing the blade under vertical light-shading state.

FIG. 8 shows a side elevation view of the present invention, showing the superimposed latticed strip under a continuously corrugated state.

FIG. 9 shows a side elevation view of the present invention, showing the blade made of common fabric under a superimposed state.

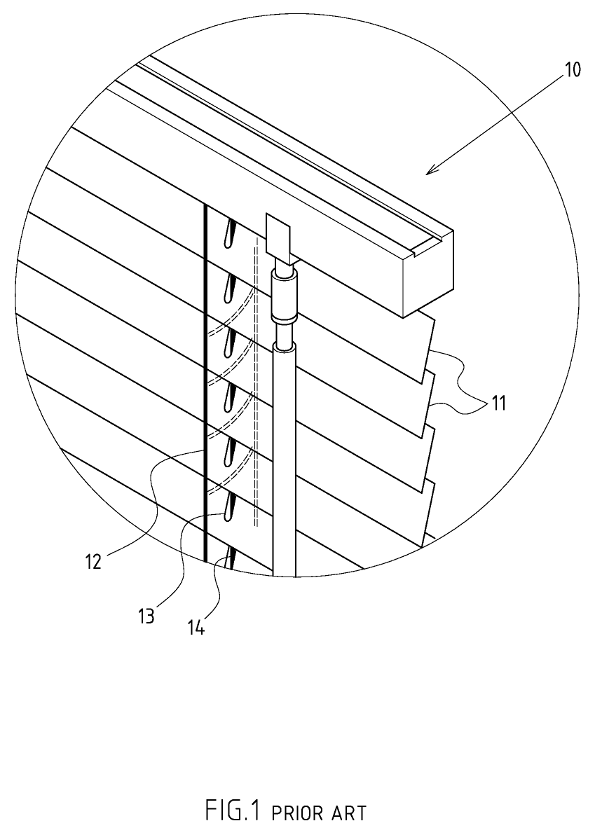

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

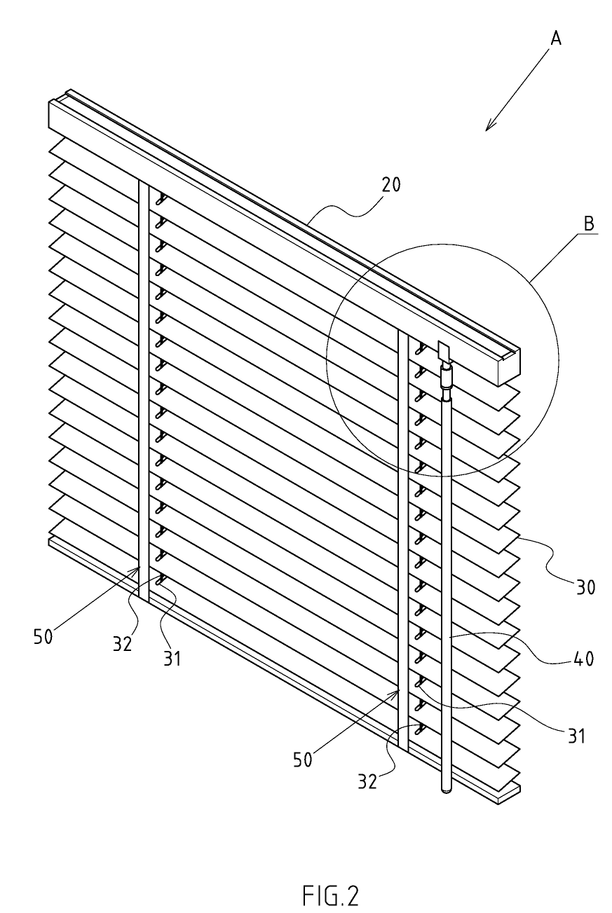

FIGS. 2-5 depict preferred embodiments of a venetian blind ofthe present invention with thin profile latticed strips. The embodiments are only provided for explanatory purposes with respect to the patent claims.

The venetian blind A of the present invention comprises a bracket 20, extended transversely, and several thin blades 30, arranged at horizontal intervals under the bracket 20. At both sides of the thin blade 30, two threading holes 31 are placed correspondingly for the penetration ofthe brake cord 32. The brake cord 32 is used for driving the rise or fall of the thin blades 30. Moreover, the thin blade 30 is made of aluminum or plastic sheets (0.1˜0.3 mm), with the exception of thin blades made of wood or a single wooden blade.

A blade regulator 40 resembles a rod, being placed on the preset location of the bracket 20 and permitting adjustment of the angle of the thin blade 30 and control the light-shading state.

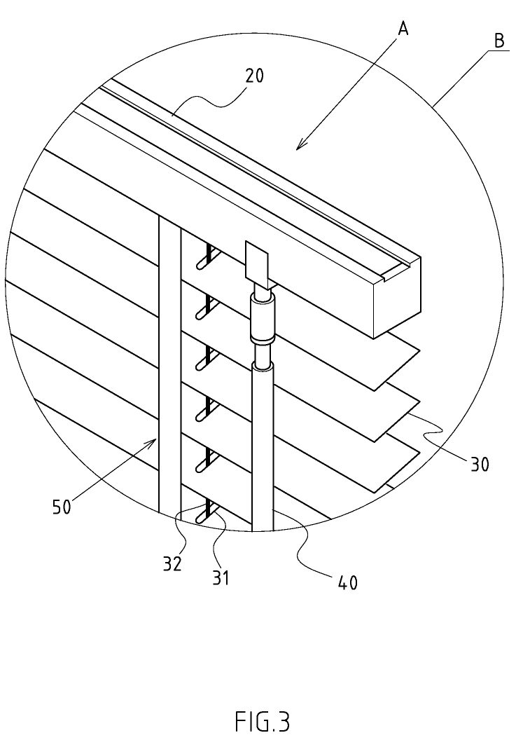

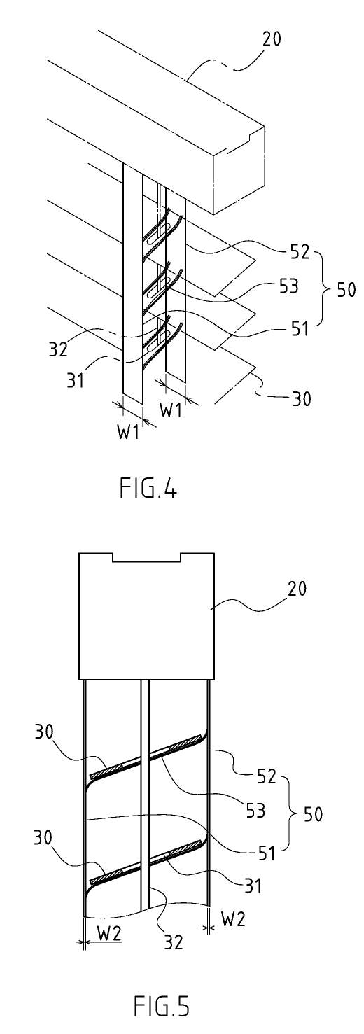

At least two narrow shaped and thin profile latticed strips 50 extend from the bottom of the bracket 20. The latticed strip 50 contains a front strip body 51 and a rear strip body 52 arranged at a vertical interval, as well as a blade span 53 set at a vertical interval and connected transversely between front and rear strip bodies. The width of front and rear strip bodies 51, 52 (shown by W1 in FIG. 4) ranges between 8˜15 mm, and the thickness (shown by W2 in FIG. 5) between 0.2˜0.4 mm. The front and rear strip bodies 51, 52 are positioned correspondingly to the threading hole 31 of the thin blade 30. The latticed strip 50 is made of fabric, and the blade span 53 is made of linear material (e.g. braided wire) or banded material (e.g. cloth).

Based upon the above-specified structures, the present invention is operated as follows:

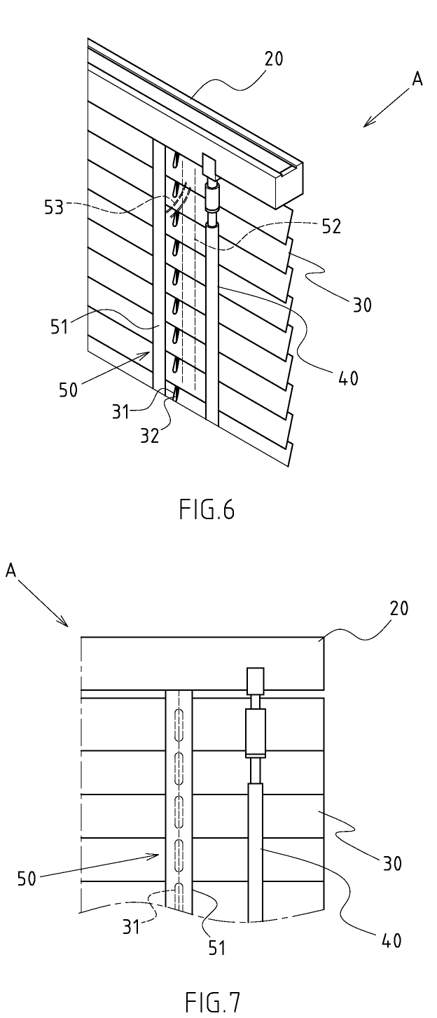

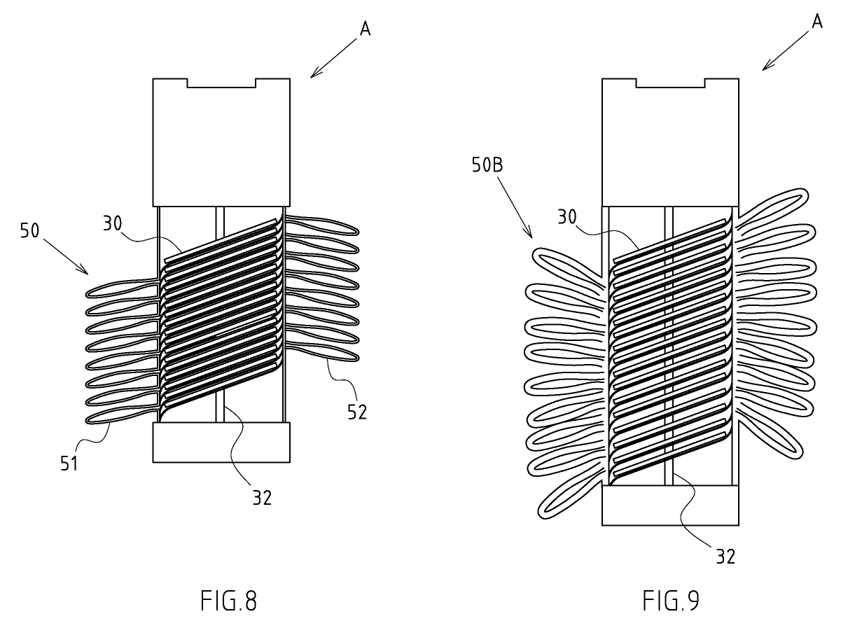

The venetian blind A of the present invention includes a thin blade 30 structurally combined with the narrow shaped and thin profile latticed strip 50. The front and rear strip bodies 51, 52 of the latticed strip 50 are positioned correspondingly to the threading hole 31 of the thin blade 30. When the thin blade 30 of the venetian blind A is adjusted to a vertical light-shading angle (as shown in FIGS. 6 and 7), the threading hole 31 of the thin blade 30 can be fully blocked to prevent any light leakage and improve the light-shading effect with the help of front and rear strip bodies 51, 52 of the latticed strip 50. Furthermore, due to the thin-profile structure ofthe latticed strip 50, when the thin blades 30 of the venetian blind A are superimposed (shown in FIG. 8), a most compact spacing among the thin blades 30 can be kept. As the thickness of front and rear strip bodies 51, 52 of the latticed strip 50 is close to that of the thin blade 30, it is possible to remain compact even if the latticed strip 50 is under a continuously corrugated state. If the latticed strip 50B of common thickness is adopted herein, as shown in FIG. 9, the bigger spacing among thin blades 30 will affect the compactness, and the corrugated latticed strip 50B of much bigger thickness than thin blade 30 will cause outward pushing with a poorer visual effect.

1. A venetian blind comprising:
a bracket, being extended transversely;
a plurality of blades of identical thickness, being arranged at horizontal intervals below said bracket, each blade having two threading holes placed at each end thereof;
a brake cord, penetrating through the threading holes;
a blade regulator, being placed on a preset location of said bracket, each blade having an angle adjusted by said blade regulator; and
at least two latticed strips extending from a bottom of said bracket, each strip having a front strip body and a rear strip body arranged at vertical intervals, as well as a blade span set at a vertical interval and connected transversely between the front and rear strip bodies, the front and rear strip bodies being positioned correspondingly to the threading holes.

2. The venetian blind defined in claim 1, wherein each blade is comprised of aluminum or plastic sheets.

3. The venetian blind defined in claim 1, wherein each strip is comprised of fabric.

4. The venetian blind defined in claim 1, wherein the blade span transversely connects between the front and rear strip bodies, the blade span being comprised of linear or banded materials.
